(19) United States
(12) Patent Application Publication
(10) Pub. No.: US 2006/0059250 A1
(43) Pub. Date: Mar. 16, 2006

(54) Remote management of computers

(76) Inventor: Jamie Robb, Moira (IE)

Correspondence Address: Ward & Olivo, 708 Third Avenue, New York, NY, 10017, US

(21) Appl. No.: 10/479,396

(22) PCT Filed: Feb. 18, 2002
(86) PCT No.: PCT/GB02/00695

§ 371 Date: Sep. 26, 2005

(30) Foreign Application Priority Data
Feb. 27, 2001 (GB) 0104835.4

(51) Int. Cl. G06F 15/177

(52) U.S. Cl. 709/221

(57) ABSTRACT

The present invention comprises a system for the control of multiple remote computers. A control computer, of the type including operating software, keyboard, monitor and a cursor control device, controls at least one remote computer or device. The control computer sends control signals to the remote computer without passing the control signals through the operating software of the control computer. The control signals are passed to the remote computer using remote control application software. The control signals may be passed directly to the remote computer using hard links, or alternatively, sent via network connections to a software filter in the remote computer. The control signals are received by the remote computer and implemented, thereby providing transparent control of a remote computer from a control computer.

This invention relates to a system and method for enabling users to control computers at a remote location over a communications link such as a network.

Remote management of computers involves accessing a computer or a network from a different location. There are many methods by which one can gain such access. Dial-up connection through a desktop modem over regular telephone lines is a common method of remote access. Remote access is also possible using a line between a “central” or main corporate local area network and a remote computer or a remote local area network. In such instances, a control computer is provided with a remote management application that controls communications between the control computer and the remote computer. The user inputs data at the control computer, which data is processed by the management application and used to control the computer at the remote location. The input data usually comprises keyboard, video and mouse signals, although other forms of signal such as that from a Universal Serial Bus (USB) connector device may also be used. If this information is to be sent over a network connection, it must first be captured and then transmitted.

Many techniques exist to capture input data, but existing methods capture the data signal after it has passed through the operating system of the control computer. One disadvantage of using existing methods of data capture when controlling a remote computer arises in the case of keyboard control. Many key depress signals are not available to the remote management application on the control computer and have an undesired effect on the operating system therein. One example of this is the “Control-Alt-Delete” key combination in Windows™ operating systems, which when depressed causes the control computer to start a shut down routine. This means that the “Control-Alt-Delete” key combination cannot be used to effect the remote computer.

Similar problems occur with mouse input data. Ideally, the control mouse movements are synchronised with mouse movements on the remote computer. Known remote management systems, however, fail to achieve this, which detracts from the look and feel of the system for the user. Another problem is that with existing systems mouse data has an effect on the operating systems of both the control computer and the remote computer. The end result of this is highly undesirable. For example, two separate moving cursors may exist, one on each computer. Synchronisation of the user (control) cursor with the cursor of the remote computer may also be problematic: once the user cursor has reached the edge of its screen, mouse movement signals to the remote computer may cease even though the remote cursor is still in the centre of its screen. This is due to differences in user-defined cursor acceleration.

In fact any difference in user-defined settings between the control computer and the remote computer adversely affects the accuracy of data representation on the latter machine. This problem is inherent in existing methods of capturing and transmitting the data signals.

Various aspects of the invention are defined in the independent claims. Some preferred features are defined in the dependent claims.

According to one aspect of this invention, there is provided a computer system comprising a control computer that is operable to control a remote computer, and has operating system software, the control computer having one or more control devices for use by a user, the control computer also having means for causing control signals from the control device(s) to be sent to the remote computer without passing through the operating system of the control computer.

By-passing the operating system of the control computer enables the control device(s) to operate as if they were physically attached to the remote computer, thus providing transparent remote control. This is advantageous.

The control devices typically comprise a keyboard and a mouse. The control computer may contain remote control application software amongst its applications. The control signals are passed directly to the remote control application. The control signals may be passed by the remote control application via hard links to corresponding control device port(s) of the remote computer. Alternatively, the control signals may be passed via a network to a software filter in the remote computer, which inserts these signals in the operating system of the remote computer.

According to another aspect of the present invention, there is provided a method of controlling a remote computer by use of one or more control devices connected to a control computer having operating system and applications software, the method comprising transmitting control signals from the control device(s) to the remote computer, whilst by-passing the operating system software of the control computer.

According to yet another aspect of the invention, there is provided a computer program, preferably on a data carrier or computer readable medium, for controlling a remote computer using one or more control devices that are associated with a control computer, the control computer having operating system software and applications software, wherein the computer program comprises instructions for establishing a communication channel or route between the or each control device and the remote computer, which route by-passes the operating system software of the control computer.

Various aspects of the invention will now be described, by way of example only, with reference to the drawings, in which:

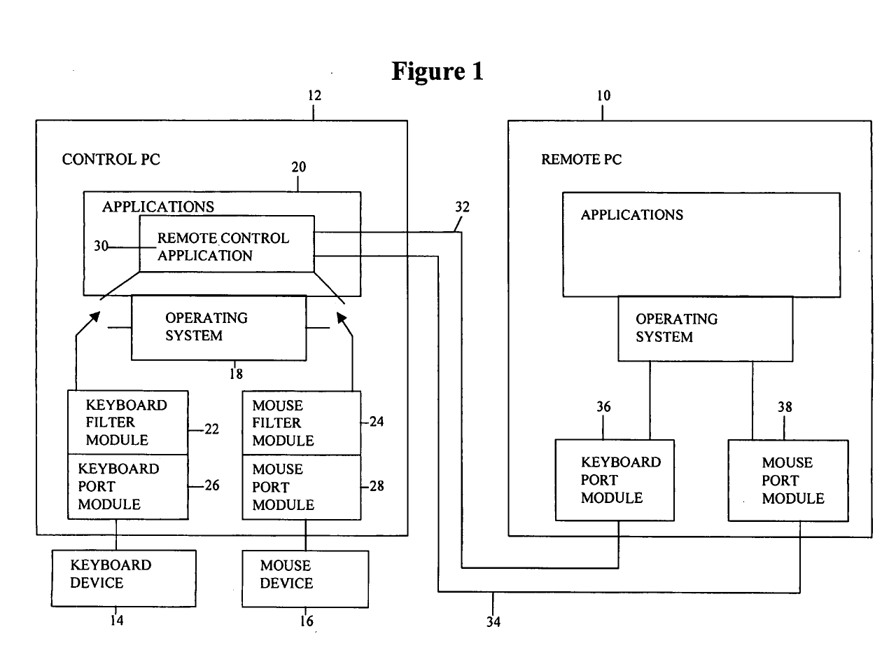

FIG. 1 is a schematic block diagram of a remote computer management system; and

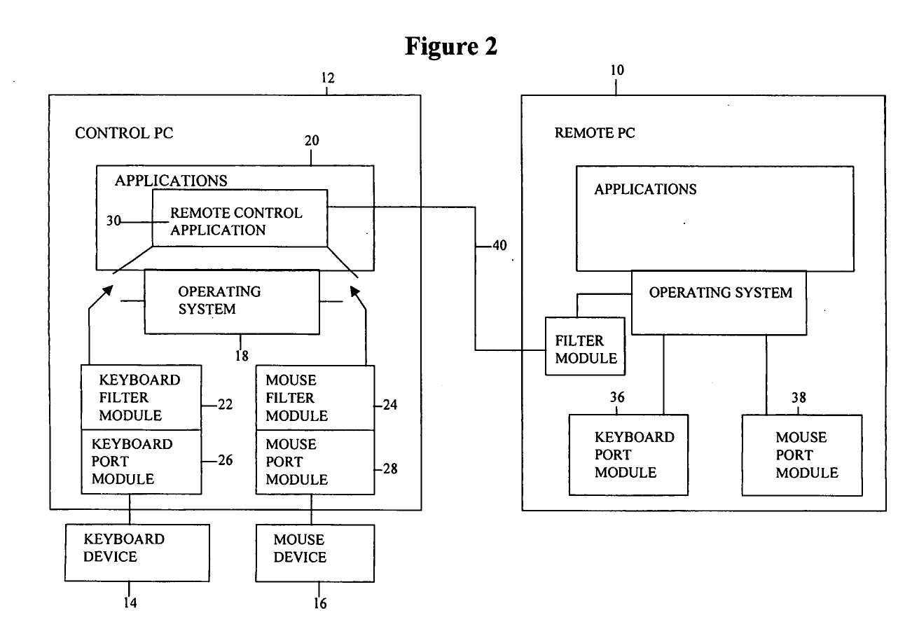

FIG. 2 is a block diagram of a modified form of the system of FIG. 1.

FIG. 1 shows a remote PC 10 that is controlled remotely by a control PC 12. The control PC 12 is provided with a keyboard device 14 and a mouse device 16. The control PC 12 in the normal way has operating system software 18 and applications software 20. Included in the applications software is a remote control application 30 for controlling communications between the control PC 12 and the remote PC 10. Between the operating system 18 and the keyboard device 14 are a keyboard port module 26 and a keyboard filter module 22′. Between the mouse device 16 and the operating system 18 are a mouse port module 28 and a mouse filter 24. In use, data from the keyboard and mouse 14 and 16 respectively is passed to the filter modules 22 and 24 via the port modules 26 and 28, these port modules being of conventional form.

To control the remote PC 10, the keyboard and mouse data has to be provided in the format in which it emanates from the devices 14 and 16. Many operating systems change the format of this data and trap various control sequences, making it difficult to send these commands transparently to the remote PC directly. In the present embodiment, the filter program modules, namely keyboard filter module 22 and mouse filter module 24, make it possible to bypass the operating system 18 of the control PC 12 and send the data directly to the remote PC 10.

Each of the filter modules 22, 24 is essentially a switch which allows the control PC 12 to operate normally, sending control commands to its operating system 18 or, when instructed, redirect all control data to an interface allowing it to be retrieved directly by the remote control application 30 residing in the application software 20. The application 30 is then responsible for relaying the data to the remote PC 10 directly via hardware links 32, 34 to the keyboard and mouse ports 36, 38 of the remote PC 10. Thus, when the control PC 12 receives the appropriate command, the remote control application 30 causes the filters 22 and 24 to establish a communication channel or route between the control devices 14, 16 and the remote control application 30, which channel or route by-passes the operating system 18 of the control PC 12. Hence, when the keyboard device 14 and the mouse 16 generate control commands for the remote computer 10, these by-pass the operating system 18 of the control computer 12 and are sent to the remote control application 18. The control signals are then sent to the remote PC 10, where they operate directly upon its operating system.

The filter or switching function may be provided by way of software, in which case the filter modules should preferably reside at the bottom of the operating system or as close to the hardware as possible.

The filter modules 22 and 24 are usually hardware independent, since they rely on port drivers to manage the hardware-specific functionality of the keyboard and mouse devices. However, where the operating system cannot support filter program modules a generic port program module may be produced to give the required functionality.

FIG. 2 shows a system that is similar to that of FIG. 1, like parts being denoted by like references. In this case, however, the remote control application software 30 relays the control device data via a network 40 to the remote PC, where another filter program module 42 reinserts the data at the base of the operating system. An advantage of doing this is that no hardware device is necessary and the remote control application software communicates directly via a filter module to the remote PCT 10, rather than via a keyboard and/or mouse physically plugged into the respective parts.

Whilst the specific embodiments are directed to the use of PCs, it will be appreciated that the invention may be applied to other types of computer.

A skilled person will appreciate that variations of the disclosed arrangements are possible without departing from the invention. Accordingly, the above description of specific embodiments is made by way of example only and not for the purposes of limitation. In particular, it will be clear to the skilled person that minor modifications can be made without significant changes to the devices and methods described above.

1-14. (canceled)

15. A system for controlling a remote computer, said system comprising:
a control computer including operating system software and a software application within said control computer, said software application for sending control signals from one or more control devices to said remote computer such that said control signals by-pass said operating system software.

16. A system according to claim 15, wherein said software application for sending control signals comprises a filter.

17. A system according to claim 16, wherein said filter is a software filter.

18. A system according to claim 17, wherein said software filter resides at a bottom of said operating system.

19. A system according to claim 15, wherein said control devices include a keyboard or a cursor control device.

20. A system according to claim 15, wherein said software application is remote control application software.

21. A system for controlling a remote computer, said system comprising:
a control computer including operating system software and a application software; and
a controller within said control computer for sending control signals from one or more control devices to said remote computer such that said control signals by-pass said operating system software.

22. A system according to claim 21, wherein said control devices include a keyboard or a cursor control device.

23. A system for controlling a remote computer, said system comprising:
a control computer having operating system software stored therein;
a software application within said control computer for sending control signals from one or more control devices to a remote computer; and
means within said control computer for sending control signals from said one or more control devices to said remote computer;
wherein said control signals by-pass said operating system software

24. A method for controlling a remote computer, said method comprising the steps of:
receiving computer control signals at a control computer from one or more control devices; and
transmitting said control signals to a remote computer via a communication path that by-passes the operating system software of said control computer.

25. A method according to claim 24, wherein said method provides for selectively sending said control signals to said remote computer.

26. A method according to claim 24, wherein said method provides for selectively sending said control signals to said control computer.

27. A method for controlling a remote computer, said method comprising the steps of:
receiving control signals using one or more control devices at a control computer; and
transmitting said control signals to a remote computer;
wherein said control signals are transmitted to said remote computer by a computer program; and
wherein said computer program is independent of an operating system of said control computer.

28. A method according to claim 27, wherein said control signals by-pass the operating system software.

29. A method according to claim 27, wherein said computer program is on a data carrier or computer readable medium.
